(19) United States
(12) Patent Application Publication
(10) Pub. No.: US 2023/0422357 A1
(43) Pub. Date: Dec. 28, 2023

(54) CIRCUIT DEVICE FOR A COOKING DEVICE, IN PARTICULAR COOKING HOB, MORE IN PARTICULAR INDUCTION COOKING HOB AND COOKING DEVICE, IN PARTICULAR COOKING HOB, MORE IN PARTICULAR INDUCTION COOKING HOB

(71) Applicant: ELECTROLUX APPLIANCES AKTIEBOLAG, Kolding (DK)

(72) Inventors: Alex VIROLI, Forli (IT); Massimo NOSTRO, Forli (IT); Massimo ZANGOLI, Forli (IT); Emanuel URGESE, Forli (IT); Alan MENGOZZI, Forli (IT)

(21) Appl. No.: 18/039,230

(22) PCT Filed: Nov. 30, 2021
(86) PCT No.: PCT/EP2021/083528

§ 371 Date: May 27, 2023

(30) Foreign Application Priority Data
Dec. 14, 2020 (EP) 20213766.7

(51) Int. Cl. H05B 6/06

(52) U.S. Cl. CPC H05B 6/062

(57) ABSTRACT

The invention relates to a circuit device (1) for a cooking device, in particular cooking hob, more in particular induction cooking hob, comprising —at least two power units (P1, P2, . . . PN), each power unit supplied with electrical power by a different mains current phase (L1, L2, . . . LN) —wherein each power unit comprises frequency converting means (G11 . . . GNM), each for supplying at least one induction element with electrical power to generate heating power, •wherein each power unit comprises at least one current pot conversion unit (C1 . . . CN) for converting an input direct or alternating current into one, at least one, two or at least two output direct currents, •wherein each power unit comprises at least one load supplied or to be supplied with electrical power by the output direct current, an output direct current or the output direct currents from the current conversion unit, •wherein a first power unit (P11) comprises a first current conversion unit (C1), in particular for converting an alternating current from a first mains current phase (L1) into one, at least one, two or at least two first output direct currents, •wherein by the first output direct current or one of the first output direct currents of the first power unit (P1), at least a second current conversion unit (C2) of a second power unit (P2) is supplied for converting the first output direct current into one, at least one, two or at least two second output direct currents.

The present invention relates to a circuit device for a cooking device, in particular cooking hob, more in particular induction cooking hob and to a cooking device, in particular cooking hob, more in particular induction cooking hob.

Circuit devices for a cooking device, in particular cooking hob, more in particular induction cooking hob, for example induction boards, are supplied from mains current (or: AC grid voltage), by a single current/voltage phase or multiple current/voltage phases. From phase-neutral voltages, frequency converting means can derive sinusoidal currents for injecting in induction elements, for example coils.

Furthermore, output direct currents, in particular low DC voltages, are generated for supplying electronics and for driving frequency converting means, in particular inverters.

Working with multiple current and/or voltage phases causes or can cause the presence of multiple voltage references in the device that can lead to electrical problems, consequently functional electrical insulation must be present between loads, control units or subsystems supplied by different phase voltages.

It is an object of the invention to provide an improved, and preferably cost effective, simpler and/or flexible, circuit device, which in particular solves at least one or more of the following problems:
Many electrical components are used for current conversion units, for example AC/DC conversion units, in circuit devices for a cooking device, in particular when supplied by at least two mains current phases.
The operation of these current conversion units increases or can increase stand-by power consumption.
Complicated and/or complex EMI (electromagnetic interference) filters are used for each current phase.
Operation with different mains current phases for small loads and control units prevents electrical insulation
Complex drivers for frequency converting means, for example generator drivers, are used.

The object is solved in particular by the circuit device according to claim 1 and by a cooking device according to claim 15. Improvements are provided in the dependent claims.

The invention relates, in claim 1, to a circuit device for a cooking device, in particular cooking hob, more in particular induction cooking hob, the circuit device comprising
at least two, in particular two or three or at least three power units, each power unit supplied with electrical power by a different mains current phase,
wherein each power unit comprises frequency converting means, each for supplying at least one induction element with electrical power to generate heating power,
wherein each power unit comprises at least one current conversion unit for converting an input direct current or an input alternating current into one, at least one, two or at least two output direct currents,
wherein each power unit comprises at least one load or at least two loads, in particular one or more low-power loads and/or control units, supplied or to be supplied with electrical power by the output direct current, an output direct current or the output direct currents from the current conversion unit,
wherein a first power unit comprises a first current conversion unit, in particular for converting an alternating current from a first mains current phase into one, at least one, two or at least two first output direct currents,
wherein by the first output direct current or one of the first output direct currents of the first power unit, at least a second current conversion unit of a second power unit is supplied for converting the first output direct current into one, at least one, two or at least two second output direct currents.

By the invention, in particular, at least one or more of the following advantages can be obtained:
Less electrical components can be used for current conversion units, for example DC/DC conversion units, in circuit devices for a cooking device, in particular when supplied by at least two mains current phases.
The interruption of the operation of these current conversion units during inactivity decreases or can decrease stand-by power consumption.
Simpler and/or less complex EMI filters are or can be used for at least some of the current phases.
Operation with the same mains current phase for small loads and control units enables or can enable electrical insulation.
Less complex drivers for frequency converting means, for example generator drivers, are or can be used.

Hence, in particular, the first output direct current or one of the first output direct currents of the first power unit is or can be the second input direct current of the second power unit. Preferably, by the invention, the first power unit can supply each other power unit with a direct current.

An input direct current can in particular be a DC input current. An input alternating current can in particular be an AC input current. An output direct current can in particular be a DC output current.

An alternating current can in particular be a current which is supplied by an alternating voltage or AC voltage, in particular between 100V and 250V or between 85V and 265V, with an input frequency, in particular between 45 Hz and 130 Hz, more in particular of 50 Hz or 65 Hz, as well as a current phase.

The current conversion unit can in particular be a DC/DC converter which converts a direct input voltage into one or more direct output voltages.

The current conversion unit can in particular be an AC/DC converter which converts an alternating input voltage into one or more direct output voltages.

A main current phase can in particular be an alternating current which is supplied with a predefined current phase. Such a current phase can be phase-shifted, for example by 120°, to different mains current phases. In particular, electrical power can be supplied by two or three different current phases which are phase shifted by 120° or 180°.

A mains current is in particular a current which is supplied by an external power net or supply net.

A load can in particular be a control unit or a fan. A load can in particular be a low power unit which is preferably supplied with power by a supply voltage of 18V or less.

In particular embodiments, at least one or each power unit is a power board, in particular mounted as or on a printed circuit board.

A printed circuit board can allow a good isolation of the different mains current phases. The usage of printed circuit boards can allow an efficient pre-mounting of the power units for the different mains current phases.

In particular embodiments, at least one or each of the current conversion units is an insulated current conversion unit, in particular an insulated AC/DC conversion unit and/or an insulated DC/DC conversion unit. This enables or can enable a good isolation of the different current phases.

In particular embodiments, the first current conversion unit is an AC/DC converter that outputs one, at least one, two or at least two direct voltages, in particular at least two different direct voltages, for example 5V and 18V, and/or currents from the first mains current phase, in particular from a single phase-neutral AC voltage or from a phase-phase AC voltage. This enables or can enable a direct power supply by the first mains current phase. A phase-phase AC voltage is or can be a typical mains voltage, for example in the United States of America.

In particular embodiments, the first current conversion unit, in particular by supplying at least a second current conversion unit and/or a third current conversion unit with electrical power, generates supply voltages for multiple loads, in particular for multiple low power loads and/or control units, in particular on at least a second power unit and/or a third power unit or each power unit and/or referred to different mains current phases and/or to different phase-neutral voltages and/or to different phase-phase AC voltages. This enables or can enable a power supply for the loads from the first power unit to at least one further power unit.

In particular embodiments, at least one of the current conversion units, in particular the or at least one current conversion unit of the second power unit and/or a third power unit, is or are DC/DC conversion units. This enables or can enable simpler and/or less complex current conversion units, as no AC/DC conversion is required in these current conversion units.

In particular embodiments, each power unit comprises at least one or only a single current conversion unit, in particular at least one or a single low power current conversion unit, for supplying currents and/or voltages to the loads, in particular the low power loads. This enables or can enable less current conversion units, as no further current conversion units are required in these power units.

In particular embodiments, only the first current conversion unit is supplied by a mains current phase, and the second current conversion unit and/or third current conversion unit is/are only supplied by the first current conversion unit. This enables or can enable simpler and/or less complex current conversion units, as no AC/DC conversion is required in these current conversion units.

In particular embodiments, at least one or each current conversion unit outputs at least two output voltages, in particular two, at least two, three or at least three different output voltages, in particular for supplying different loads. This enables or can enable the power supply of a larger variety of loads.

In particular embodiments, the first power unit is electrically connected with each of the other power units, in particular with the second power unit and/or third power unit, for supplying voltages for loads, in particular for low power loads and/or control units, in particular on each power unit and/or power units referred to different mains current phases and/or to different phase-neutral voltages and/or to different phase-phase AC voltages. This enables or can enable simpler and/or less complex current conversion units, as no AC/DC conversion is required in these current conversion units.

In particular embodiments, the first current conversion unit of the first power unit is electrically connected with the current conversion units of each of the other power units for supplying voltages for all control units, in particular on each power unit and/or on power units referred to different mains current phases and/or to different phase-neutral voltages and/or to different phase-phase AC voltages.

In particular embodiments, a control unit is provided to turn-on or turn-off current conversion units, in particular insulated power supplies, of each power unit or of the second power unit and/or the third power unit.

In particular embodiments, the total power from the frequency converting means of each mains current phase is limited by a control unit to a predetermined maximum power, which in particular limits the individual power of each frequency converting means to ensure that total power is below the or a rated power of each mains current phase. This enables or can enable the operation of, in particular a single, frequency converting means with a higher power.

In particular embodiments, the predetermined maximum power, which limits the power of the frequency converting means on each current phase such that that the total power, is below the or a maximum rated power of each current phase.

In particular embodiments, the cooking device comprises induction elements, wherein each power unit supplies or is configured to supply at least one induction element, in particular induction coil, with electrical power by a frequency converting means, preferably to generate heating energy for heating a cooking vessel disposed on the induction element or coil. This enables or can enable to provide heating energy to the induction elements.

In particular embodiments, on each power unit, by a different current phase, one, at least one, two, at least two, three, at least three, four or at least four frequency converting means are supplied with electrical power.

In particular embodiments, each power unit comprises frequency converting means for supplying at least one induction element with electrical power from the mains current phase supplying the power unit with electrical power.

In particular embodiments, a frequency converting means is a means or inverter or generator for converting an input current with an input frequency, in particular between 45 Hz and 130 Hz, more in particular of 50 Hz or 65 Hz, into an output current with a high frequency, in particular with a frequency between 10 kHz and 100 kHz. This enables or can enable to provide heating energy to the induction elements.

In particular embodiments, a frequency converting means comprises at least one, in particular common, rectifying means and/or, in particular in series, at least one frequency generation means driven with a driving frequency, wherein the driving frequency is supplied with electrical power by a control unit, wherein in particular the control unit is supplied with electrical power by a or the current conversion unit of the power unit.

The invention relates to a cooking device, in particular cooking hob, more in particular induction cooking hob, with a circuit device according to the invention.

The present invention will be described in further detail with reference to the drawing, in which

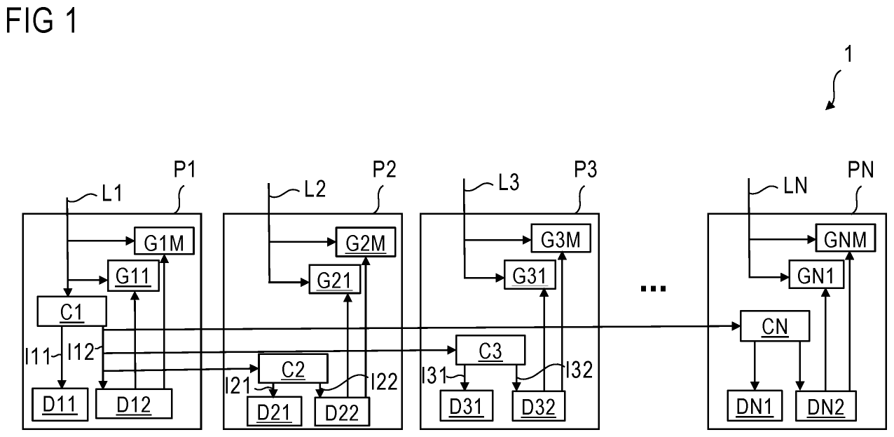

FIG. 1 shows a circuit device according to an embodiment of the present invention.

FIG. 1 shows a circuit device 1 according to an embodiment of the present invention.

The circuit device 1 is intended for a cooking device, in particular cooking hob, more in particular induction cooking hob.

The circuit device 1 comprises at least two, in particular two, three or at least three power units P1, P2, . . . PN, each power unit supplied with electrical power by a different mains current phase L1, L2, . . . LN.

Each power unit P1, P2, . . . PN comprises frequency converting means G11 . . . GNM, each for supplying at least one induction element with electrical power to generate heating power.

Each power unit P1, P2, . . . PM comprises at least one current conversion unit C1 . . . CN for converting an input direct or alternating current into one, at least one, two or at least two output direct currents.

Each power unit P1, P2, . . . PN comprises at least one load or at least two loads, in particular one or more low-power loads and/or control units, supplied or to be supplied with electrical power by the output direct current, an output direct current or the different output direct currents from the current conversion unit.

The first power unit P1 comprises a first current conversion unit C1, for converting an alternating current from a first mains current phase L1 into two first output direct currents I11 and I12.

By one of the first output direct currents I12 of the first power unit P1, a second current conversion unit C2 of a second power unit P2 is supplied for converting the first output direct current I12 into two output direct currents I21 and I22.

Hence, one of the first output direct currents is or can be the second input direct current. By the invention, the first power unit P1 can supply each other power unit with a direct current.

By one of the first output direct currents I12 of the first power unit P1, a third current conversion unit C3 of a third power unit P3 is supplied for converting the first output direct current I12 into two output direct currents I31 and I32.

An input direct current is, for power units P2 and P3, a DC input current.

An input alternating current is, for power unit P1, an AC input current.

An output direct current is a DC output current.

An alternating current can be a current which is supplied by an alternating voltage or AC voltage, in particular between 100V and 250V or between 85V and 265V.

Each of the current conversion units C2, C3 . . . CN is a DC/DC converter which converts a direct input voltage into two direct output voltages.

The current conversion unit C1 is an AC/DC converter which converts an alternating input voltage L1 into two direct output voltages.

A main current phase can in particular be an alternating current which is supplied with a predefined current phase. Such a current phase can be phase-shifted, for example by 120°, to different mains current phases. In particular, electrical power can be supplied by two or three different current phases which are phase shifted by 120° or 180°.

A mains current is a current which is supplied by an external power net or supply net.

A load can be a control unit or a fan. A load can in particular be a low power unit which is preferably supplied with power by a supply voltage of 18V or less.

Each power unit P1, P2, . . . PN is a power board, in particular mounted as or on a printed circuit board.

A printed circuit board can allow a good isolation of the different mains current phases. The usage of printed circuit boards can allow an efficient pre-mounting of the power units for the different mains current phases.

Each of the current conversion units C1 . . . CN is an insulated current conversion unit, in particular an insulated AC/DC conversion unit C1 and insulated DC/DC conversion units C2 . . . CN.

This can enable a good electrical isolation of the different current phases.

The first current conversion unit C1 is an AC/DC converter that outputs two direct voltages, in particular two different direct voltages, for example 5V and 18V, and currents from the first mains current phase L1, in particular from a single phase-neutral AC voltage or from a phase-phase AC voltage.

The first current conversion unit C1, by supplying at least a second current conversion unit C2 and a third current conversion unit C3, generates supply voltages for multiple loads, in particular multiple low power loads and/or control units, on at least a second power unit P2 and a third power unit P3 or each power unit P1 . . . PN, referred to different mains current phases L1, L2, . . . LN and to different phase-neutral voltages and/or to different phase-phase AC voltages.

At least one of the current conversion units C1 . . . CN, in particular the conversion units C2, C3 of the second power unit P2 and a third power unit P3, are DC/DC conversion units.

Each power unit P1 . . . PN comprises at least one or only a single current conversion unit C1 . . . CN, in particular at least one or a single low power current conversion unit, for supplying currents and/or voltages to the loads, in particular the low power loads.

Only the first current conversion unit C1 is supplied by a mains current phase L1, and the second current conversion unit C2 and the third current conversion unit C3 are only supplied by the first current conversion unit C1.

Each current conversion unit C1 . . . CN outputs at least two output voltages, in particular two different output voltages, in particular for supplying different loads.

The first power unit P1 is electrically connected with each of the other power units P2 . . . PN, in particular with the second power unit P2 and third power unit P3, for supplying voltages for loads, in particular low power loads and/or control units, on each power unit P1 . . . PN and power units referred to different mains current phases L1 . . . LN and to different phase-neutral voltages and/or to different phase-phase AC voltages.

The first current conversion unit of the first power unit is electrically connected with the current conversion units of each of the other power units for supplying voltages for all control units, on each power unit and on power units referred to different mains current phases and to different phase-neutral voltages and/or to different phase-phase AC voltages.

The circuit device 1 comprises a control unit to turn-on or turn-off current conversion units, in particular insulated power supplies, of each power unit or of the second power unit and/or the third power unit.

The total power from the frequency converting means G11 . . . GNM of each mains current phase L1 . . . LN is limited by a control unit to a predetermined maximum power, which limits the individual power of each frequency converting means G11 . . . GNM to ensure that total power is below the rated power of each mains current phase L1 . . . LN.

The predetermined maximum power, which limits the power of the frequency converting means on each current phase such that the total power, is below the maximum rated power of each current phase.

The circuit device 1 comprises induction elements, wherein each power unit P1 . . . PN supplies or is configured to supply at least one induction element with electrical power by a frequency converting means G1M . . . GNM.

On each power unit P1 . . . PN, by a different current phase L1 . . . LN, one, at least one, two, at least two, three, at least three, four or at least four frequency converting means G1M . . . GNM are supplied with electrical power.

Each power unit P1, P2, . . . PM comprises frequency converting means G1M . . . GNM for supplying at least one induction element with electrical power from the mains current phase L1, L2, . . . LM supplying the power unit P1, P2, . . . PM with electrical power.

A frequency converting means G1M . . . GNM is a means or generator for converting an input current with an input frequency, in particular between 45 Hz and 130 Hz, more in particular of 50 Hz or of into an output current with a high frequency, in particular with a frequency between 10 kHz and 100 kHz.

A frequency converting means G1M . . . GNM comprises at least one, in particular common, rectifying means and/or, in particular in series, at least one frequency generation means driven with a driving frequency.

The driving frequency is supplied with electrical power by a control unit, wherein the control unit is supplied with electrical power by the current conversion unit C1 . . . CN of the power unit P1 . . . PN.

The circuit device 1 relates to and/or is part of and/or operates a cooking device, in particular cooking hob, more in particular induction cooking hob, with a circuit device 1.

### LIST OF REFERENCE NUMERALS

1 Circuit device
P1 . . . PN Power units
L1 . . . LN Mains current phases
G11 . . . GNM Frequency converting means
C1 . . . CN Current conversion units
I11 . . . IN2 First output direct currents
D11 . . . DN2 Loads

1. Circuit device for a cooking device, comprising:
at least two power units, each power unit supplied with electrical power by a different mains current phase,
wherein each power unit comprises frequency converting means, each for supplying at least one induction element with electrical power to generate heating power,
wherein each power unit comprises at least one current conversion unit for converting an input direct or alternating current into at least one output direct current,
wherein each power unit comprises at least one load supplied with electrical power by the output direct current from the current conversion unit,
wherein by a first output direct current of a first output direct currents of a first power unit, at least a second current conversion unit of a second power unit is supplied for converting the first output direct current into at least one second output direct currents.

2. Circuit device according to claim 1,
wherein at least one of the current conversion units is an insulated current conversion unit.

3. Circuit device according to claim 1,
wherein the first current conversion unit is an AC/DC converter that outputs at least one direct voltage and/or current from the first mains current phase.

4. Circuit device according to claim 1,
wherein the first current conversion unit, by supplying at least the second current conversion unit, generates supply voltages for multiple loads on at least the second power unit and/or referred to different mains current phases and/or to different phase-neutral voltages or to different phase-phase AC voltages.

5. Circuit device according to claim 1,
wherein at least one of the current conversion units is a DC/DC conversion unit.

6. Circuit device according to claim 1,
wherein each power unit comprises at least one conversion unit for supplying currents and/or voltages to the loads.

7. Circuit device according to claim 1,
wherein only the first current conversion unit is supplied by a mains current phase, and the second current conversion unit is only supplied by the first current conversion unit.

8. Circuit device according to claim 1,
wherein at least one outputs at least one output voltage for supplying different loads.

9. Circuit device according to claim 1,
wherein the first power unit is electrically connected with each of the other power units for supplying voltages for loads.

10. Circuit device according to claim 1,
wherein the total power from the frequency converting means of each mains current phase is limited by a control unit to a predetermined maximum power to ensure that total power is below the rated power of each mains current phase.

11. Circuit device according to claim 1,
comprising induction elements, wherein each power unit supplies at least one induction element with electrical power by the frequency converting means.

12. Circuit device according to claim 1,
wherein on each power unit, by a different current phase, at least one frequency converting means is supplied with electrical power.

13. Circuit device according to claim 1,
wherein the frequency converting means is a generator for converting an input current with an input frequency into an output current with a high frequency.

14. Circuit device according to claim 1,
wherein the frequency converting means comprises at least one rectifying means and/or at least one frequency generation means driven with a driving frequency, wherein the driving frequency is supplied with electrical power by a control unit, wherein the control unit is supplied with electrical power by the current conversion unit of the power unit.

15. Cooking device with the circuit device according to claim 1.

16. A circuit device for an induction cooking hob, comprising:
a first induction cooking element;
a second induction cooking element;
a first power unit comprising a first frequency converter, a first current converter, and a controller; and
a second power unit comprising a second frequency converter, a second current converter, and a second controller,
wherein the first and second frequency converters are configured to convert an input mains current between 45 Hz or 130 Hz into an high-frequency current with a frequency between 10 kHz and 100 kHz, and to output the high-frequency current to the first and second induction cooking elements, respectively,
wherein the first and second frequency converters comprise a rectifier and a frequency generator connected in series, the rectifier being common to the first and second frequency converters,
wherein the first current converter is an insulated AC/DC current converter and is configured to convert an input alternating mains current into two first direct currents, and to output one of the two first direct currents to the first controller and another of the two first currents to the second current converter,
wherein the second current converter is an insulated DC/DC current converter and is configured to convert the other of the two first currents into a second direct current, and to output the second direct current to the second controller,
wherein two first direct currents have different voltages and the different voltages are between 5V and 18V, and
wherein the first and second controllers are configured to output a driving frequency signal to the generators of the first and second frequency converters, respectively, and
wherein, by controlling the output driving frequency signals, the first and second controllers are configured to limit a total power of the first and second frequency generators, respectively, to a predetermined maximum power such that a total power is below a rated power of each mains current phase.
